(19) United States
(12) Patent Application Publication
(10) Pub. No.: US 2005/0155065 A1
(43) Pub. Date: Jul. 14, 2005

(54) Method and network system for timer-recording broadcast program

(75) Inventor: Sang Sun Lee, Seoul (KR)

Correspondence Address: BIRCH STEWART KOLASCH & BIRCH, PO BOX 747, FALLS CHURCH, VA, 22040-0747, US

(73) Assignee: LG Electronics Inc.

(21) Appl. No.: 11/033,280

(22) Filed: Jan. 12, 2005

(30) Foreign Application Priority Data
Jan. 13, 2004 (KR) P2004-2301

(51) Int. Cl. H04N 5/445; G06F 13/00; G06F 3/00; H04N 5/91

(52) U.S. Cl. 725/58

(57) ABSTRACT

A method and network system for timer-recording a broadcast program, which can store broadcast programs desired by a user and provide the stored broadcast programs to a display device of the user through a network whenever the user desires, is disclosed. The method includes transmitting a request for timer-recording from a display device to a server through a network, recording a broadcast program at the server according to the timer-recording request, and adding program information of the recorded broadcast program to user-specific recording status information stored in the server.

This application claims the benefit of the Korean Patent Application No. 10-2004-0002301, filed on Jan. 13, 2004, which is hereby incorporated by reference as if fully set forth herein.

### BACKGROUND OF THE INVENTION

1. Field of the Invention

The present invention relates to a network system, and more particularly, to a method and network system for timer-recording a broadcast program. Although the present invention is suitable for a wide scope of applications, it is particularly suitable for recording a broadcast program desired by a user and providing the user with the recorded broadcast program.

2. Discussion of the Related Art

Provided that a broadband (or wideband) network of an asynchronous transfer mode (ATM) is supplied even to general households, in the future, a user may be able to connect to a server that provides diverse information and to transfer and receive (or upload and download) desired data in real-time. Accordingly, the user may receive and view high definition video and audio data in real-time through the network. In recent technology, video on demand (VOD) services are the most general type of service that provides video and audio data through a network. A VOD server stores video data of movies or broadcast programs and provides the stored video data to users through the network, depending upon requests made by the clients connected to the network. However, in case of the VOD services, the user is required to search for the data he or she wishes to receive (or download) among the wide range of video data that are already stored within the VOD server. If the desired data is not found in the VOD server, then the user is unable to receive (or download) and view the desired video data.

### SUMMARY OF THE INVENTION

Accordingly, the present invention is directed to a method and network system for timer-recording a broadcast program that substantially obviates one or more problems due to limitations and disadvantages of the related art.

An object of the present invention is to provide a method and network system for timer-recording a broadcast program that can store into a server a broadcast program desired by a user and provide the stored broadcast program to a display device of the user through a network system.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a method for timer-recording a broadcast program in a network system includes transmitting a request for timer-recording from a display device to a server through a network, recording a broadcast program at the server according to the timer-recording request, and adding program information of the recorded broadcast program to user-specific recording status information stored in the server. Herein, the transmitting a request for timer-recording to a server may include logging-in to the server, displaying a timer-recording menu stored in the server on the display device, and transmitting a request for timer-recording to the server, the request including information of a broadcast program selected from the timer-recording menu.

The method for timer-recording a broadcast program in a network system may further include displaying the user-specific recording status information stored in the server on the display device, selecting the recorded broadcast program from the user-specific recording status information, and transmitting the selected broadcast program from the server to the display device through the network. Herein, the network may be any one of an internet network, an intranet network, and a home network.

In another aspect of the present invention, a method for timer-recording a broadcast program in a network system includes searching recording status information corresponding to one of a display device ID and a user ID from a server, displaying the recording status information on a corresponding display device, selecting a broadcast program from the displayed recording status information, transmitting the selected broadcast program from the server to the display device through a network, and displaying the transmitted broadcast program on the display device. Herein, the recording status information may include at least one of channel identification, program title, and broadcast time information of each broadcast program stored in the server.

In a further aspect of the present invention, a network system for timer-recording a broadcast program includes at least one display device sending a timer-recording request for recording a broadcast program or a viewing request for viewing a broadcast program through a network, and a server recording a broadcast program and storing a user-specific recording status information based on the timer-recording request, and transmitting the recorded broadcast program to a corresponding display device based on the viewing request through the network.

The server may store information specific to each of the display devices and may also search the recording status information corresponding to one of a display device ID and a user ID from a server. The server may include a receiver receiving the broadcast program, a data storage storing the received broadcast program and the recording status information, and a controller recording a broadcast program based on the timer-recording request, and transmitting the recorded broadcast program to the display device based on the viewing request.

The display device may display the recording status information stored in the server onto a screen based on a user command. And, the display device may include a network adapter being corrected to the server through the network, an audio/video processor converting video data of the recorded broadcast program, which is transmitted from the server, into a displayable signal, and transmitting audio data of the recorded broadcast program to a speaker, and a microcomputer sending one of the timer-recording request and the viewing request based on a user command.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiments of the invention and together with the description serve to explain the principle of the invention. In the drawings:

FIG. 1 illustrates a structure of a network system according to the present invention;

FIG. 2 illustrates a detailed view of the structure of a server and a display device of FIG. 1;

FIG. 3 illustrates a method for timer-recording a broadcast program in the network system according to the present invention;

FIG. 4 illustrates an example of a timer-recording menu according to the present invention;

FIG. 5 illustrates an example of user-specific recording status information according to the present invention; and

FIG. 6 illustrates another example of user-specific recording status information according to the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

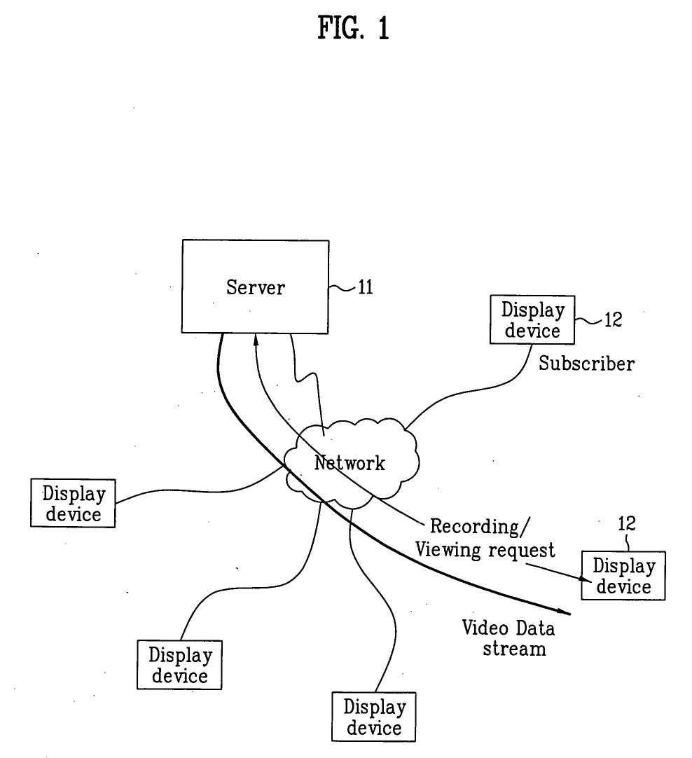

FIG. 1 illustrates a structure of a network system according to the present invention. Referring to FIG. 1, a server 11 is connected to a plurality of display devices through a network. The network consists of one of an internet network, an intranet network, and a home network. The server 11 receives a recording (or video-recording) request made by a user from the display device 12 through the network. Then, depending upon the user's request, the server 11 records the corresponding broadcast program and records a set of user-specific recording status information. The user-specific recording status information includes channel identification, program title, and broadcast time information of broadcast programs that are to be recorded, and also includes recording status information, which includes charnel identification, program title, and broadcast time information of broadcast programs that have been recorded in the past. Furthermore, the server 11 provides the recorded broadcast program and the user-specific recording status information to the display device 12 depending upon a command (or request) of the user.

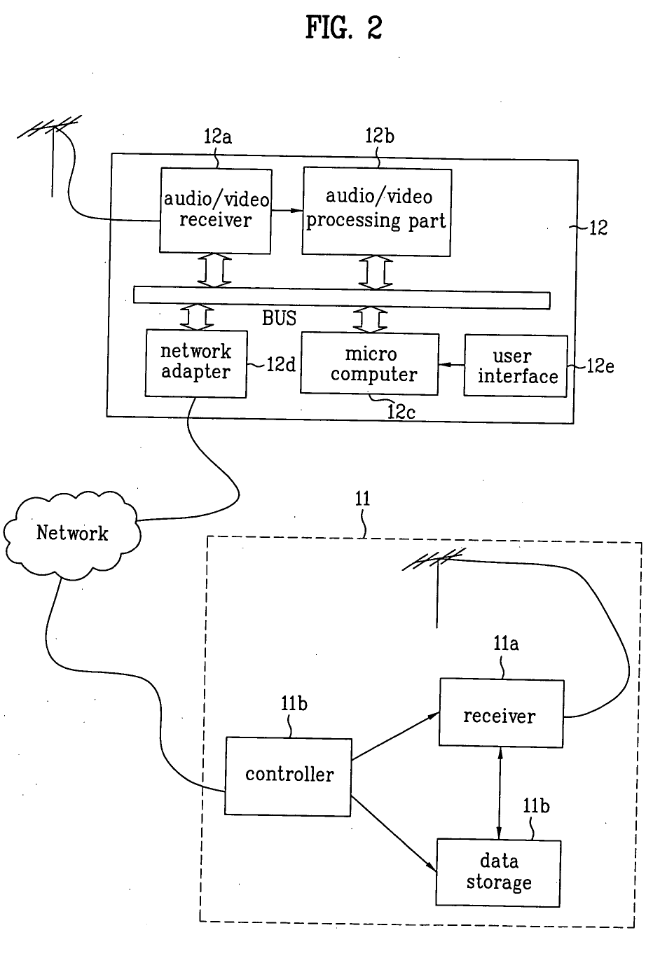

Referring to FIG. 2, the server 11 includes a receiver 11a, which receives the broadcast program. The receiver 11a includes any one of a tuner, a set-top box, a cable broadcast program receiver receiving air waves. A data storage 11c of the server 11 stores the broadcast programs and also stores user information corresponding to each display device 12 and user-specific recording status information. In addition, the data storage 11c may also store video and audio data inputted from external devices, such as a digital versatile disc (DVD) player or a video cassette recorder (VCR). A controller 11b of the server 11 controls the receiver 11a so that the receiver 11a selects and receives broadcast programs desired by the user depending upon the timer-recording request (or request for timer-recording) of the user. Then, the controller 11b stores the received broadcast program in the data storage 11c. And, the controller 11b transmits the broadcast program stored in the data storage 11c to the display device 12 based on the user-specific recording status information.

The display device 12 is either connected to the server 11 depending upon the command of the user, or connected automatically to the server 11. The display device 12 displays a menu for recording a program. Also, the display device 12 receives the recorded program or the user-specific recording status information from the server 11. Herein, the display device 12 can be any one of a personal computer (PC), a personal digital assistant (PDA), a portable media player (PMP), and a mobile phone.

A network adapter 12d of the display device 12 is connected to the server 11 through the network and exchanges data with the server 11. An audio/video receiver 12a of the display device 12 either separates the data received from the network adapter 12d into audio data and video data, or separates the signal inputted from a tuner or any other external device into an audio data and a video data. Herein, the audio/video receiver 12a may be a demultiplexer. An audio/video processor 12b of the display device 12 receives the audio data and the video data from the audio/video receiver 12a. Then, the audio/video processor 12b provides the audio data to a speaker and converts the video data into a displayable signal. The audio/video processor 12b includes an audio processor and a video processor. A microcomputer 12c of the display device 12 either displays a menu onto the screen for inputting a timer-recording request, or displays the user-specific recording status information received from the server 11 onto the screen.

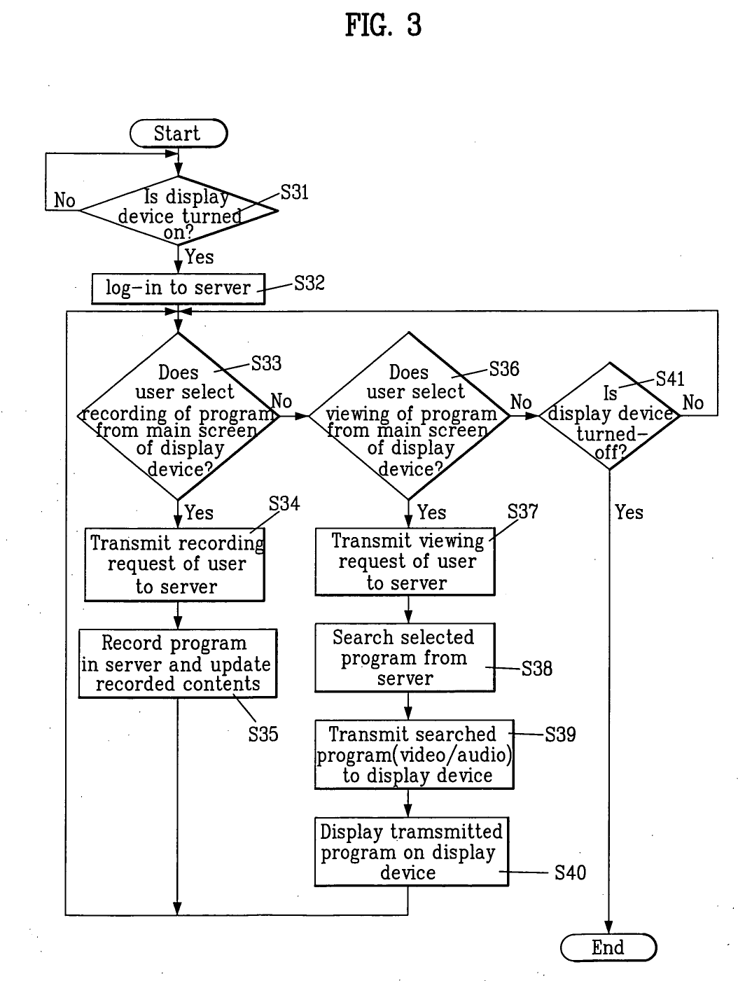

A method for timer-recording a broadcast program in the network system according to the present invention will now be described in detail. FIG. 3 illustrates the method for timer-recording a broadcast program in the network system according to the present invention. Referring to FIG. 3, when the display device 12 is turned on (S31), the microcomputer 12c uses a given (or assigned) ID so as to automatically log-in to the server 11 (S32). The ID may be any one of an ID assigned during a fabrication process of the display device 12, an ID assigned by the server 11, and a user ID. The function of the display device 12 automatically logging-in to the server 11 may be modified (or changed) by the user. For example, the user may use an on-screen display (OSD) menu, which is provided by the microcomputer 12c, in order to turn the automatic log-in function “on” or “off”.

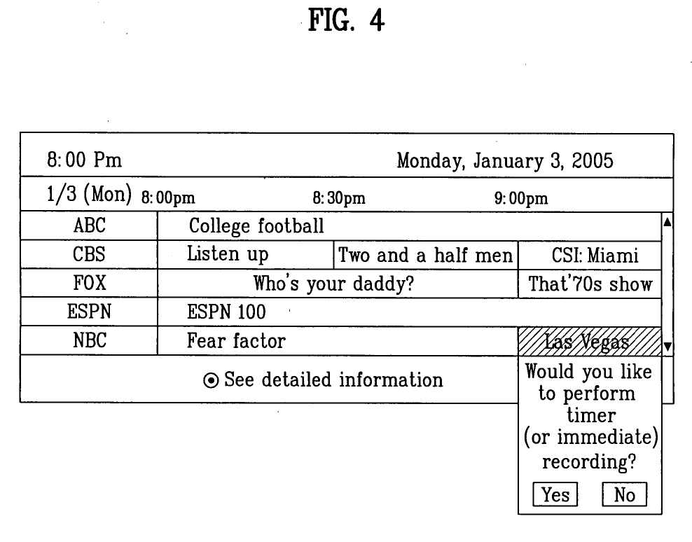

The user can use a user interface 12e, such as a remote controller or a key panel, in order to select a reserved recording option or a viewing option. When the user selects the reserved recording option (S33), the microcomputer 12c reads an electronic program guide (EPG) from the server 11 and displays a timer-recording menu including the EPG onto the screen. FIG. 4 illustrates an example of the timer-recording menu according to the present invention. Referring to FIG. 4, the user may select from the timer-recording menu a broadcast program he or she wishes to record. When the user selects the broadcast program that is to be recorded, the microcomputer 12c transmits the timer-recording request of the user to the server 11 (S34). The timer-recording request that is transmitted to the server 11 includes information related to the selected broadcast program (e.g., title or ID of the program). The controller 11b of the server 11 receives the timer-recording request from the display device 12 and, then, updates the stored user-specific recording status information in accordance with the newly received timer-recording request (S35). At this point, the controller 11b reads the ID of the display device 12 or reads the user ID corresponding to the user-specific recording status information from the data storage 11c. Subsequently, the controller 11b adds data (or information) of the corresponding broadcast program that is to be recorded, such as the channel identification, program title, and broadcast time information of the program, to the user-specific recording status information. Thereafter, the controller 11b stores the updated user-specific recording status information to the data storage 11c.

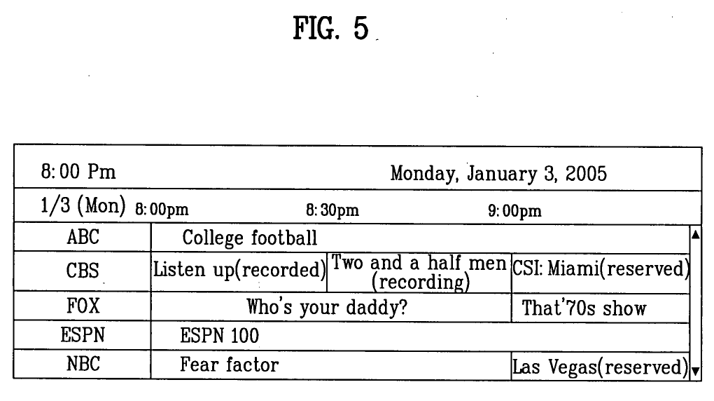

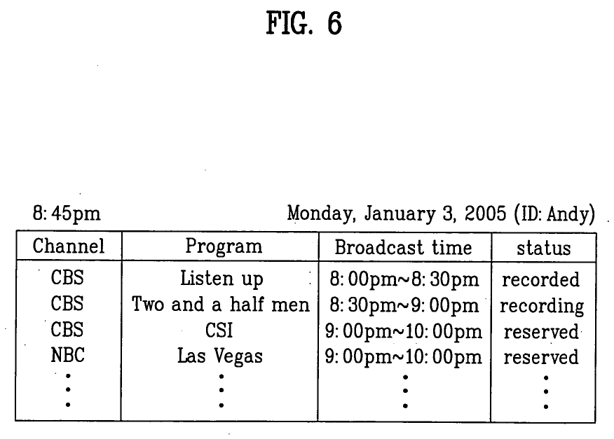

FIG. 5 illustrates an example of user-specific recording status information according to the present invention. Referring to FIG. 5, the user-specific recording status information indicates on the EPG broadcast programs that have been recorded, broadcast programs that are being recorded, and broadcast programs that are reserved (or programmed) for recording. FIG. 6 illustrates another example of user-specific recording status information according to the present invention. The user-specific recording status information shown in FIG. 6 includes only broadcast programs that have been recorded and broadcast programs that are reserved for recording. Accordingly, the user can easily search the broadcast programs that have already been recorded and the broadcast programs that are reserved for recording.

The controller 11b records the broadcast programs based on the user-specific recording status information stored in the data storage 11c. More specifically, when it becomes the time reserved for recording, the controller 11b receives the corresponding program through the receiver 11a and, then, stores the received broadcast program in the data storage 11c. Also, the controller 11b adds information, such as channel identification, program title, and broadcast time information of the stored broadcast program, to the user-specific recording status information. When the user selects the viewing option (S36), the microcomputer 12c reads the user-specific recording status information from the server 11 and displays the read user-specific recording status information onto the screen. When the user selects a broadcast program from the user-specific recording status information window, shown in FIG. 5 and FIG. 6, for his or her viewing, the microcomputer 12c transmits the user's viewing request to the server 11 (S37).

Herein, the viewing request includes information of the selected broadcast program. For example, when the user selects a broadcast program in order to view one of the recorded broadcast programs, the microcomputer 12c transmits the viewing request to the server 11. Accordingly, the controller 11b of the server 11 refers to a series of broadcast programs stored in the data storage 11c based on the user-specific recording status information, so as to search and find the selected broadcast program (S38). After finding the audio data and the video data corresponding to the broadcast program, which is selected by the user, the controller 11b transmits the audio data and the video data to the corresponding display device 12 (S39). The display device 12 receives the audio data and the video data corresponding to the selected broadcast program from the server 11 and, then, displays the received audio and video data onto the screen (S40). Thus, the user can view the desired broadcast program stored in the server 11.

When the user selects a broadcast program that is presently being broadcasted from the user-specific recording status information window, the microcomputer 12c transmits the user's viewing request to the server 11. Then, depending upon the viewing request made by the user, the controller 11b receives audio and video data corresponding to the selected broadcast program through the receiver 11a. Thereafter, the controller 11b transmits in real-time the received audio and video data to the corresponding display device 12. Accordingly, the display device 12 receives the audio and video data corresponding to the selected broadcast program from the server 11 and, then, displays the received audio and video data onto the screen. Thus, the display device 12 may receive and display in real-time broadcast programs that are presently being broadcasted. Finally, when the user wishes to turn the display device 12 off (S41), the microcomputer 12c terminates all programs and functions that were activated and shuts down the power.

As described above, the method and network system for timer-recording a broadcast program has the following advantages. A user may store a plurality of broadcast programs and also diverse types of data (or information) into his or her display device, even when the storage capacity of the display device is small. Most particularly, the user may also reserve recording of specific broadcast programs, and the user may use user-specific recording status information stored in a server of the network system, so as to select and view a stored broadcast program.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

1. A method for timer-recording a broadcast program in a network system, comprising:
transmitting a request for timer-recording from a display device to a server through a network;
recording a broadcast program at the server according to the timer-recording request; and
adding program information of the recorded broadcast program to user-specific recording status information stored in the server.

2. The method of claim 1, wherein the transmitting a request for timer-recording to a server comprises:
logging-in to the server;
displaying a timer-recording menu stored in the server on the display device; and
transmitting a request for timer-recording to the server, the request including information of a broadcast program selected from the timer-recording menu.

3. The method of claim 2, wherein the timer-recording menu includes an electronic program guide (EPG).

4. The method of claim 1, wherein information of the recorded broadcast program includes at least one of channel identification, program title, and broadcast time information.

5. The method of claim 1, wherein the user-specific recording status information includes information of broadcast programs that are to be recorded, and information of broadcast programs that have been recorded.

6. The method of claim 1, further comprising:
displaying the user-specific recording status information stored in the server on the display device;
selecting the recorded broadcast program from the user-specific recording status information; and
transmitting the selected broadcast program from the server to the display device through the network.

7. The method of claim 1, wherein the network is any one of an internet network, an intranet network, and a home network.

8. A method for timer-recording a broadcast program in a network system, comprising:
searching recording status information corresponding to one of a display device 1D and a user ID from a server;
displaying the recording status information on a corresponding display device;
selecting a broadcast program from the displayed recording status information;
transmitting the selected broadcast program from the server to the display device through a network; and
displaying the transmitted broadcast program on the display device.

9. The method of claim 8, wherein the recording status information includes at least one of channel identification, program title, and broadcast time information of each broadcast program stored in the server.

10. The method of claim 8, wherein the network is any one of an internet network, an intranet network, and a home network.

11. A network system for timer-recording a broadcast program, comprising:
at least one display device sending a timer-recording request for recording a broadcast program or a viewing request for viewing a broadcast program through a network; and
a server recording a broadcast program and storing a user-specific recording status information according to the timer-recording request, and transmitting the recorded broadcast program to a corresponding display device based on the viewing request through the network.

12. The system of claim 11, wherein the server stores information specific to each of the display devices.

13. The system of claim 11, wherein the display device displays the recording status information stored in the server onto a screen based on a user command.

14. The system of claim 11, wherein the display device comprises:
a network adapter being connected to the server through the network;
an audio/video processor converting video data of the recorded broadcast program, which is transmitted from the server, into a displayable signal, and transmitting audio data of the recorded broadcast program to a speaker; and
a microcomputer sending one of the timer-recording request and the viewing request based on a user command.

15. The system of claim 11, wherein the server comprises:
a receiver receiving the broadcast program;
a data storage storing the received broadcast program and the recording status information; and
a controller recording a broadcast program based on the timer-recording request, and transmitting the recorded broadcast program to the display device based on the viewing request.

16. The system of claim 11, wherein the server searches the recording status information corresponding to one of a display device ID and a user ID from a server.

17. The system of claim 11, wherein the recording status information includes at least one of channel identification, program title, and broadcast time information of the recorded broadcast program.

18. The system of claim 11, wherein the network is of any one of an internet network, an intranet network, and a home network.
